(19) United States
(12) Patent Application Publication
(10) Pub. No.: US 2009/0084419 A1
(43) Pub. Date: Apr. 2, 2009

(54) PAINT ROLLER COVER CLEANER

(76) Inventor: Orin William Inglis, Auburn, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/239,314

(22) Filed: Sep. 26, 2008

Related U.S. Application Data
(60) Provisional application No. 60/976,366, filed on Sep. 28, 2007.

(51) Int. Cl. B08B 13/00

(52) U.S. Cl. 134/137

(57) ABSTRACT

A cleaning device for paint roller covers having a shell with one or more tapered body sections encircling a central axis between a first substantially circular opening at a wide end of the shell and a second substantially circular opening at a narrow end of the shell, the one or more tapered body sections sized to apply increasing frictional resistance to a paint roller cover when passed therethrough to effectively clean the cover. The cleaning device may include a plurality of notches or relief cuts spaced about a periphery of the narrow end and may include a flange extending from the wide end.

### CROSS-REFERENCE TO RELATED APPLICATION

This application claims the benefit under 35 U.S.C. § 119(e) of U.S. Provisional Patent Application No. 60/976,366 filed Sep. 28, 2007, which is incorporated herein by reference in its entirety.

### BACKGROUND

1. Technical Field

This disclosure is generally related to devices for cleaning paint equipment, and more particularly to a device for cleaning paint roller covers.

2. Description of the Related Art

Devices for cleaning paint roller covers are known in the art, and fall into three general categories: (a) scraper-type devices; (b) soak-type devices; and (c) spin-style devices.

Scraper-type devices are designed to include a circular aperture or curved surface feature that can be pulled over a roller cover to scrape paint from the surface thereof. Examples of such devices include those described in U.S. Patent Publication No. 2008/0047084 to Mowe and U.S. Pat. No. 6,125,497 to Galbreath. Generally, scraper-type devices leave residual paint within the nap of the roller cover and are thus ineffective in adequately cleaning beyond the exterior surface of the cover. In addition, scraper-type devices are generally difficult to manipulate and lack versatility in the ability to clean a wide range of roller cover designs.

Soak-type devices function by saturating paint roller covers with an abundant amount of water (and sometimes pressure) in an attempt to dilute paint away from the roller cover. An example of such a device is shown in U.S. Pat. No. 7,325,557 to Wallace, Ill. Generally, soak-type devices result in an abundant use of water and rely on adequate water (or solvent) penetration to effectively clean roller covers. These devices are relatively complex and expensive.

Spin-style devices are characterized by the use of centrifugal force to propel diluted paint from the surface of roller covers. Examples of such devices are found in U.S. Patent Publication Nos. 2008/0105284 to Bates and 2008/0072932 to Nicholas. Like soak-type devices, spin-style devices are relatively complex and expensive for the task of cleaning roller covers.

Accordingly, improved paint roller cover cleaning devices are desirable.

### BRIEF SUMMARY

A cleaning method and device that effectively cleans paint roller covers of varying sizes and nap thicknesses in a simple and compact form is highly desirable. The device should be relatively inexpensive and easy to use and should allow for graduated and/or gradual removal of paint from the roller cover.

Various embodiments of a cleaning device configured for removal of paint from a roller cover comprise a shell having one or more tapered body sections encircling a central axis between a first substantially circular opening at a wide end of the shell and a second substantially circular opening at a narrow end of the shell, the one or more tapered body sections sized to apply increasing frictional resistance to a paint roller cover when passed therethrough.

The shell of the cleaning device may further include a plurality of notches or relief cuts spaced about a periphery of the narrow end and may include a flange or other protruding feature at the wide end. The shell may also include one or more intermediate body sections formed integrally with and proximate the one or more tapered body sections, the one or more intermediate body sections extending parallel to the central axis or having a draft angle.

In some embodiments, the first substantially circular opening of the shell is defined by a first inner diameter and the second substantially circular opening is defined by a second inner diameter, the ratio of the first inner diameter to the second inner diameter defined by the relationship 3.0≧ID₁/ID₂>1.0.

In some embodiments, a draft angle of each of the one or more tapered body sections is sized to allow a cavity defined by the shell to receive a successively smaller cleaning device having substantially proportional features.

Further objects and advantages of the cleaning devices and methods for cleaning paint roller covers taught herein will become clear by studying the disclosure, drawings and claims.

### BRIEF DESCRIPTION OF THE SEVERAL VIEWS OF THE DRAWINGS

FIG. 1 is a front view of a paint roller cover cleaner, according to one illustrated embodiment.

FIG. 2 is a cross-sectional view of the paint roller cover cleaner of FIG. 1.

FIG. 3 is a front perspective view of the paint roller cover cleaner of FIG. 1.

FIG. 4 is a perspective view of the paint roller cover cleaner of FIG. 1 in operation.

FIG. 5 is a perspective view of a series of paint roller cover cleaners of different sizes.

### DETAILED DESCRIPTION

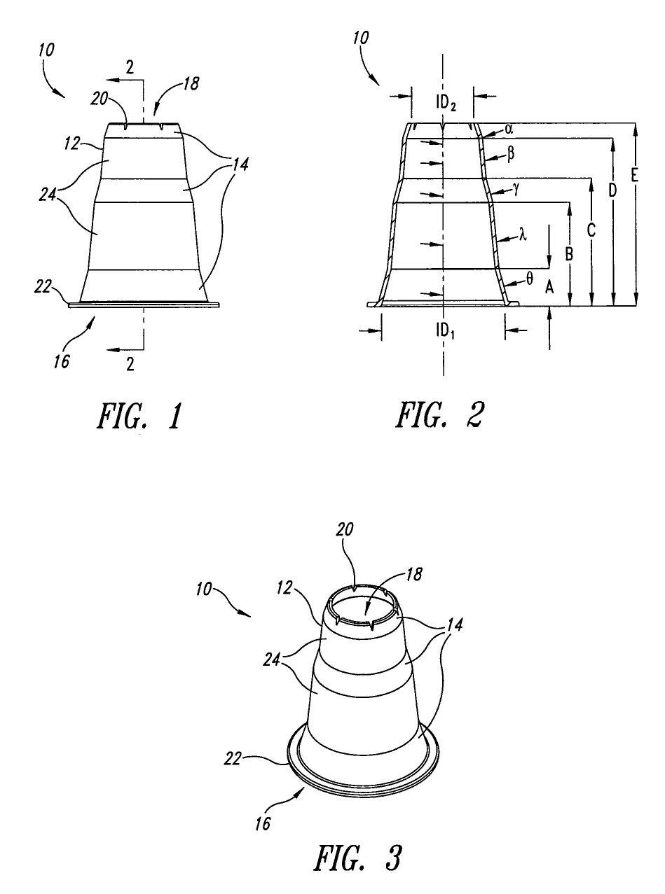

FIGS. 1-3 illustrate one embodiment of a cleaning device 10 for removing paint from a roller cover. The cleaning device 10 includes a shell-like body structure 12 having one or more tapered body sections 14 encircling a central axis between a wide end (entry end) 16 of the shell 12 and a narrow end (exit end) 18 of the same. Although the illustrated embodiment includes three tapered body sections 14, the cleaning device 10 may include more or less tapered body sections 14, including a single tapered body section that extends a full length of the shell 12. While any suitable material and manufacturing process may be used, the cleaning device 10 is preferably formed of a thermoplastic material via an injection molding process. When formed of a thermoplastic material, the shell 12 preferably has a thickness between 2 mm and 3 mm which allows for some flexing during the cleaning process.

Each of the one or more tapered body sections 14 of the shell 12 includes a draft angle (α, γ, θ) up to 45 degrees, and preferably in the range of 12 to 20 degrees. The draft angle (α, γ, θ) of each tapered body section 14 can be the same as any other tapered body section 14 or may be different. The tapered body sections 14 are configured to apply increasing frictional resistance to a paint roller cover when the cover is passed through the cleaning device 10.

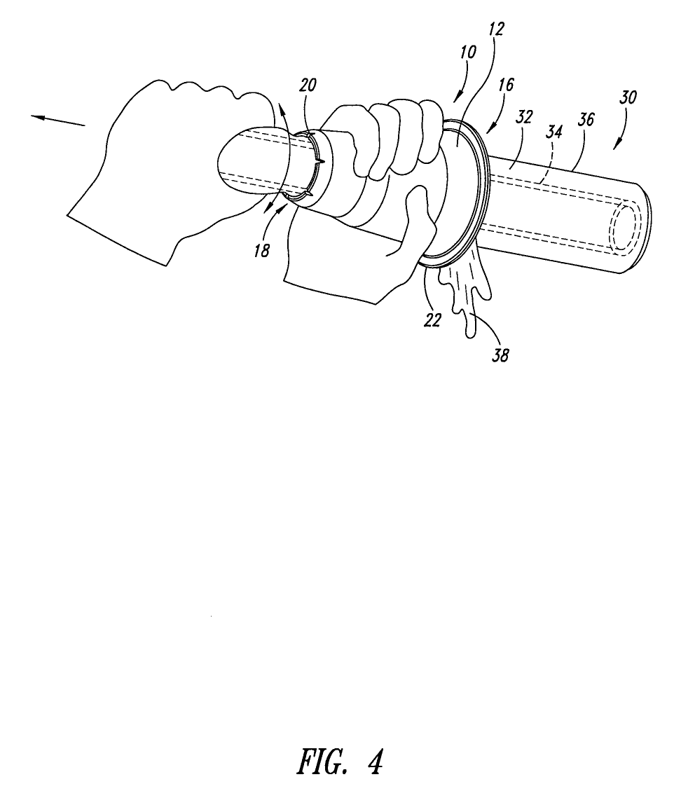

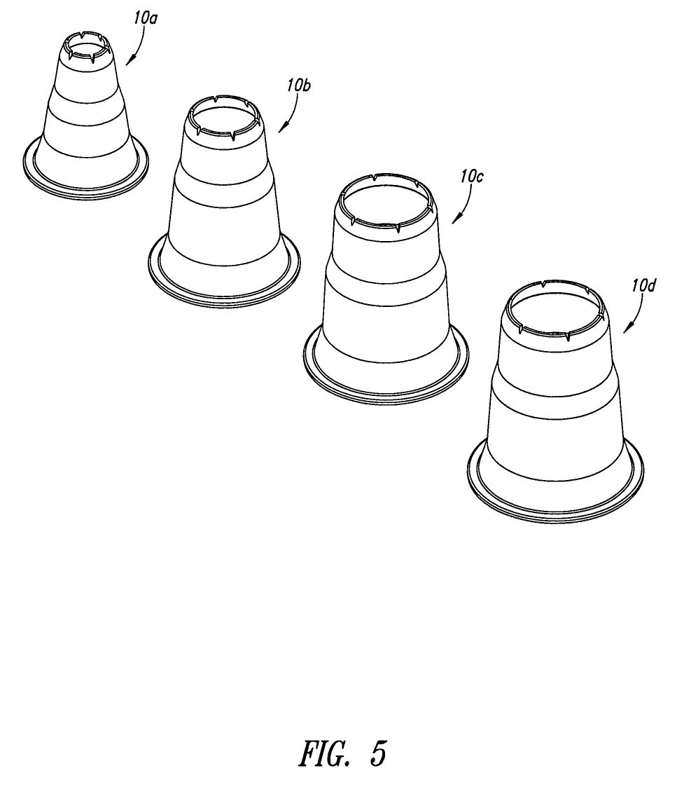

The cleaning device 10 has a substantially circular opening defined by a first inner diameter ID₁ at the wide end 16 for receiving an end of a paint roller cover during cleaning, and another substantially circular opening defined by a second inner diameter ID₂ at the narrow end 18. The second inner diameter ID₂ is sized smaller than the first inner diameter ID₁ such that a roller cover passing through the device is subjected to increased resistance as it exits through the narrow end 18 of the device 10. In some embodiments, the ratio of the first inner diameter ID₁ to the second inner diameter ID₂ is defined by the relationship 3.0≧ID1/ID2>1.0 and in other embodiments by the relationship 2.0≧ID1/ID2≧1.5. To prevent excessive resistance and provide relief from pressure developed during the cleaning process, notches or relief cuts 20 may be spaced about the periphery of the narrow end 18 of the device 10. The notches or relief cuts 20 can be spaced at equal intervals (as shown in FIG. 3) or can be spaced irregularly. Although the illustrated embodiment includes six notches or relief cuts 20, any number can be used. Alternatively, notches or relief cuts 20 may be omitted.

In some embodiments, a flange 22 extends from the wide end 16 of the device 10 to enable a user to clean a roller cover without the device slipping through the user's hand. Although the illustrated embodiment shows a radially extending flange 22, other protruding features, such as, for example, a bead, rib or lip, may be used to prevent slippage between a user's hand and the device 10. In some embodiments, surface texturing may be used on the exterior surface of the device 10 to prevent slippage.

As further illustrated in FIGS. 1-3, the shell 12 of the cleaning device 10 may include one or more intermediate body sections 24 formed integrally with and proximate tapered body sections 14. Each of the one or more intermediate body sections may extend parallel to the central axis or may include a draft angle (β, λ). When the intermediate body sections 24 include a draft angle (β, λ), the draft angle (β, λ) of the intermediate body sections 24 is generally less than the draft angle (α, γ, θ) of any tapered body sections 14 and preferably less than 10 degrees. The draft angle (β, λ) of each intermediate body section 24 can be the same as any other intermediate body section 24 or may be different therefrom.

Operation of the cleaning device is described with reference to FIG. 4. As shown, the cleaning device 10 enables a user to remove paint 38 from a roller cover 30 by grasping the cleaning device 10 with one hand and pulling and/or twisting the cover 30 through the cleaning device 10 with the other. Initially, as the roller cover 30 is fed into the wide end 16 of the device 10, the cover 30 may or may not come into contact with the shell 12 depending on the size of the cover 30 and nap 32 thereon. If contact is not made initially, then contact is made at a subsequent section of the shell 12 where the interior profile is reduced. As the cover 30 contacts the cleaning device 10 and continues therethrough, the cover 30 is subjected to increasing frictional resistance as it interacts with the tapered body sections and/or intermediate body sections. In this manner, paint 38 is removed from the roller cover 30 in a gradual and/or step-wise fashion. The removed paint 38 exits via the wide end 16 of the device 10 and may be collected in a receptacle for reuse, recycling, or disposal.

Accordingly, the paint removal process allows for quick and effective cleaning when passing a roller cover 30 through a right-sized cleaning device 10. A right-sized cleaning device 10 is sized such that the peripheral edge of the narrow end 18 is slightly larger than a core diameter 34 of the roller cover 30 but less than an outer diameter 36 of the roller cover 30. For example, when a roller cover 30 having a regular to heavy nap and a core diameter 34 of about 15 mm is passed through the cleaning device 10, the second inner diameter ID₂ at the narrow end 18 of the device 10 should be sized between 18 mm and 22 mm, and preferably about 20 mm. Likewise, when a roller cover 30 having a regular to heavy nap and a core diameter 34 of about 30 mm is passed through the cleaning device 10, the second inner diameter ID₂ should be sized between 31.5 mm and 35.5 mm, and preferably about 33.5 mm. For a roller cover 30 having a regular nap and a core diameter 34 of about 42 mm, the second inner diameter ID₂ should be sized between 44.5 mm and 48.5 mm, and preferably about 46.5 mm. For a roller cover 30 having a heavy nap and a core diameter 34 of about 42 mm, the second inner diameter ID₂ should be sized between 46.5 mm and 50.5 mm, and preferably about 48.5 mm. When sized appropriately, the periphery of the narrow end 18 provides a final cleaning edge that is effective in removing substantially all residual paint from the roller cover 30. As previously described, the narrow end 18 may include notches or relief cuts 20 to relieve pressure developed in the cleaning process and thereby ease extraction of the cover 30 from the cleaning device 10.

Controlling the general overall draft of the cleaning device 10 further aids in the effective removal of paint and provides a comfortable hand hold for users. Accordingly, for cleaning devices 30 having a second inner diameter ID₂ set to about 20 mm, the first inner diameter ID₁ at the wide end 16 of the device 10 should be set between 43 mm and 63 mm, and preferably between 48 mm and 58 mm. Likewise, for cleaning devices 30 having a second inner diameter ID₂ set to about 30 mm, the first inner diameter ID₁ should be set between 57 mm and 77 mm, and preferably between 62 mm and 72 mm. For cleaning devices 30 having a second inner diameter ID₂ set to about 42 mm, the first inner diameter ID₁ should be set between 66 mm and 91 mm, and preferably between 71 mm and 86 mm. Because the size of the first inner diameter ID₁ at the entrance of the device 10 is relatively less critical to effective cleaning than the second inner diameter ID₂ at the exit end of the device 10, it is appreciated that values of the first inner diameter ID₁ can vary to a greater extent than the second inner diameter ID₂ while still providing effective cleaning. Furthermore, a preferred size of the first inner diameter ID₁ will vary in accordance with a length of the device 10, i.e., a longer device having the same second inner diameter ID₂ as a shorter device should feature a larger first inner diameter ID₁.

While a single pass may be sufficient to remove a majority of the paint 38 from a roller cover 30, additional passes through the device 10 are preferred for effective cleaning. Additionally, rinsing the roller cover 30 between passes is advantageous. Accordingly, a preferred cleaning method comprises: selecting a cleaning device 10 having an inner diameter ID₂ at a narrow end 18 thereof sized smaller than an outer diameter 36 of a roller cover 30 and greater than a core diameter 34 of the same; passing the roller cover 30 through one or more tapered body sections 14 of the cleaning device 10 to subject the roller cover 30 to increasing frictional resistance such that paint 38 is removed therefrom; and rinsing the roller cover 30 with a solvent (e.g., water). A user may repeat passing the roller cover 30 through the device 10 and rinsing the roller cover 30 as necessary to remove residual paint. Once the paint roller cover 30 is effectively cleaned, the cover 30 can be dried for immediate reuse.

Because roller covers 30 come in a variety of sizes with varying nap thicknesses, it is beneficial to provide cleaning devices 10 of various sizes with varying diametric dimensions to effectively clean a wide range of commercially available roller covers 30. For this reason, as illustrated in FIG. 5, a series of cleaning devices 10a-d may be provided with each cleaning device 10a-d having substantially proportional features. Each device 10a-d can include external markings and/or color coding to indicate compatibility between a given cleaning device 10a-d and roller cover size. For example, a color code or marking may signal, for example, that an extra-large cleaning device 10d can be used for large and heavy nap roller covers, whereas a small cleaning device 10a can be used for small or mini-roller covers. Additionally, each device 10a-d can be sized, for example, by defining the draft angle(s) and/or other dimensions of the cleaning device 10a-d to allow a cavity defined by the device to receive a successively smaller cleaning device having substantially proportional features. In this manner, each of a series of cleaning devices 10a-d can be conveniently stacked or nested for display, packaging or storage.

Although any given cleaning device can be uniquely dimensioned for a specific roller cover, it has been found that a kit comprising four cleaning devices 10a-d is sufficient to effectively clean a substantial portion of commercially available paint roller covers, each cleaning device 10a-d defined, with reference to FIG. 2, by the height dimensions (mm), draft angles (degrees) and exit diameter (mm) set forth in the chart below.

| ID₂ | A | B | C | D | E | α | β | γ | λ | θ |
|---|---|---|---|---|---|---|---|---|---|---|
| 48.5 | 21 | 60 | 73 | 101 | 110 | 18 | 4 | 15 | 4 | 15 |
| 46.5 | 21 | 57 | 70 | 97 | 105 | 18 | 3 | 15 | 3 | 15 |
| 33.5 | 21 | 57 | 70 | 92 | 100 | 18 | 5 | 15 | 5 | 15 |
| 20.0 | 21 | 40 | 53 | 72 | 80 | 18 | 7 | 15 | 7 | 15 |

So dimensioned, the kit of cleaning devices 10a-d provides a convenient, environmentally-friendly tool set for do-it-yourself and professional painters to effectively clean a wide range of paint roller covers in a quick, simple and reliable manner, and all in a reduced form factor or package.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A cleaning device for paint roller covers, comprising:
a shell having one or more tapered body sections encircling a central axis between a first substantially circular opening at a wide end of the shell and a second substantially circular opening at a narrow end of the shell, the one or more tapered body sections sized to apply increasing frictional resistance to a paint roller cover when passed therethrough; and
a plurality of notches spaced about a periphery of the narrow end of the shell.

2. The cleaning device of claim 1, further comprising:
one or more intermediate body sections formed integrally with and proximate the one or more tapered body sections.

3. The cleaning device of claim 2 wherein the one or more intermediate body sections have a draft angle.

4. The cleaning device of claim 2 wherein the one or more intermediate body sections extend parallel to the central axis.

5. The cleaning device of claim 1, further comprising:
a flange extending from the wide end of the shell.

6. The cleaning device of claim 1 wherein the first substantially circular opening is defined by a first inner diameter and the second substantially circular opening is defined by a second inner diameter, the ratio of the first inner diameter to the second inner diameter defined by the relationship 3.0≧ID₁/ID₂>1.0.

7. The cleaning device of claim 1 wherein a draft angle of each of the one or more tapered body sections is sized to allow a cavity defined by the shell to receive a successively smaller cleaning device having substantially proportional features.

8. A cleaning device for paint roller covers, comprising:
a shell having one or more tapered body sections encircling a central axis between a first substantially circular opening at a wide end of the shell and a second substantially circular opening at a narrow end of the shell, the one or more tapered body sections sized to apply increasing frictional resistance to a paint roller cover when passed therethrough; and
a flange extending from the wide end of the shell.

9. The cleaning device of claim 8, further comprising:
one or more intermediate body sections formed integrally with and proximate the one or more tapered body sections.

10. The cleaning device of claim 9 wherein the one or more intermediate body sections have a draft angle.

11. The cleaning device of claim 9 wherein the one or more intermediate body sections extend parallel to the central axis.

12. The cleaning device of claim 8, further comprising:
a plurality of notches spaced about a periphery of the narrow end of the shell.

13. The cleaning device of claim 8 wherein the first substantially circular opening is defined by a first inner diameter and the second substantially circular opening is defined by a second inner diameter, the ratio of the first inner diameter to the second inner diameter defined by the relationship 3.0≧ID₁/ID₂>1.0.

14. The cleaning device of claim 8 wherein a draft angle of each of the one or more tapered body sections is sized to allow a cavity defined by the shell to receive a successively smaller cleaning device having substantially proportional features.
